(19) United States
(12) Patent Application Publication
(10) Pub. No.: US 2018/0137570 A1
(43) Pub. Date: May 17, 2018

(54) DEVICES, METHODS AND COMPUTER PROGRAM PRODUCTS PROVIDING USER INTERFACES FOR VISUALIZATION OF USER INPUTS AND RESPONSES THERETO

(71) Applicant: Worden Brothers, Inc., Wilmington, NC (US)

(72) Inventors: Christopher Donald Worden, Wilmington, NC (US); Ole Arthur Pederson, Wilmington, NC (US)

(21) Appl. No.: 15/812,743

(22) Filed: Nov. 14, 2017

Related U.S. Application Data
(60) Provisional application No. 62/422,367, filed on Nov. 15, 2016.

(51) Int. Cl. G06Q 40/04; G06F 3/0484; G06F 3/0481

(52) U.S. Cl. CPC G06Q 40/04; G06F 3/04817; G06F 3/0484

(57) ABSTRACT

Devices, methods, and computer program products providing user interfaces for visualization of user inputs may include generating a dynamic visualization interface for display, the dynamic visualization interface including indicia of selection, respective ones of the indicia of selection corresponding to variables associated with at least one contract; a plurality of increasing numbers corresponding to one or more of the indicia of selection; and a graphical indication that indicates a plurality of magnitudes of values that are dependent on the indicia of selection, monitoring one or more input devices of the computer system for adjustment to the one or more of the indicia of selection, and responsive to the adjustment to the indicia of selection, regenerating the dynamic visualization interface to reconfigure the graphical indication to adjust respective ones of the plurality of magnitudes of the values for respective ones of the plurality of increasing numbers.

### RELATED APPLICATIONS

This non-provisional patent application claims priority to U.S. provisional patent application 62/422,367, filed Nov. 15, 2016, entitled “DEVICES, METHODS AND COMPUTER PROGRAM PRODUCTS PROVIDING USER INTERFACES FOR VISUALIZATION OF USER INPUTS AND RESPONSES THERETO”, the disclosure of which is incorporated herein in its entirety by reference.

### COPYRIGHT PROTECTED MATERIAL

A portion of the disclosure of this patent document contains material which is subject to copyright protection. The copyright owner, Worden Brothers, Inc. of Wilmington, N.C., has no objection to the reproduction by anyone of the patent document or the patent disclosure, as it appears in the Patent and Trademark Office patent file or records, but otherwise reserves all copyright rights whatsoever.

### FIELD

Various embodiments described herein relate to devices, methods, and computer program products for dynamic generation of user interfaces.

### BACKGROUND

Electronic trading utilizing computer systems and networks are a frequent way in which electronic contracts are traded. The electronic trading may be performed using remote computers which connect to external computers over a communication network. Users wishing to perform trades and/or form contracts may submit orders related to their desired transaction over the communication network.

As the market underlying the electronic trading becomes more complex, so too does the types of trades and contracts that can be performed. There are multiple variables which can impact a given contract, and modern trading strategy often calls for multiple contracts to be combined so as to hedge against risk. In addition, the dynamic nature of the market underlying the contract increases the complexity of the trading operation. Multiple variables that may impact a particular strategy may also be continually changing due to other trades or market conditions.

In order to reduce risk associated with the transaction, it may be beneficial to execute contracts as close together in time as possible, if not simultaneously. While modern systems may be able to reduce the amount of time between trades, it is still challenging for an individual user of an electronic trading system to incorporate, and visualize, the multiple variables that are both dynamically changing and simultaneously impacting the value, and therefore the risk, of the contract or combination of contracts.

As the underlying assets for the electronic contracts can change quickly in a robust market, users of electronic trading systems benefit from the ability to visualize the risk of an overall market strategy, and understand the changes to that risk with potential changes to the terms of the electronic contracts which the user can control, as well as the dynamic changes to the underlying market which the user cannot control.

In existing trading applications, multiple interfaces of information may be required to input potential parameters for a contract, or contracts, being contemplated and evaluate those parameters. The sheer amount of data being presented may become difficult to visualize. Compounding the problem for a user of such a system are the underlying market changes. As a user changes from a first interface illustrating one aspect of a potential contract to another interface illustrating other aspects of the potential contract, the data on the first interface may already be obsolete due to market changes. As a result, any comparison the user may attempt to make with prior-presented data may be incorrect. Similarly, if the user wishes to change some portion of the underlying contract, the user must revisit each of the interfaces to evaluate the risk, compounding the possibility of calculating risk with obsolete data.

### SUMMARY

Various embodiments described herein provide devices, methods, and computer program products for providing user interfaces for visualization of user inputs and responses thereto.

According to some embodiments described herein, a computer program product for electronically visualizing contracts includes a non-transitory computer readable storage medium having computer readable program code embodied in the medium that when executed by at least one processor causes the at least one processor to perform operations including: generating a dynamic visualization interface for display on a computer system, the dynamic visualization interface including: at least one strike price selector extending in a first direction, the at least one strike price selector corresponding to a strike price associated with at least one contract to be electronically traded; a first axis extending in a second direction, crossing the first direction, the first axis including a plurality of increasing prices of an underlying asset of the at least one contract, wherein the at least one strike price selector is configured to be graphically adjusted to select at least one of the plurality of increasing prices; a graphical profit zone extending from the first axis and associated with a first group of the plurality of increasing prices, the graphical profit zone indicating a plurality of net profit values for the at least one contract that is associated with respective prices of the first group of the plurality of increasing prices; and a graphical loss zone extending from the first axis and associated with a second group of the plurality of increasing prices, the graphical loss zone indicating a plurality of net loss values for the at least one contract that is associated with respective prices of the second group of the plurality of increasing prices; monitoring one or more input devices of the computer system for adjustment to the at least one strike price selector; responsive to the adjustment to the at least one strike price selector, regenerating the dynamic visualization interface to reconfigure the graphical profit zone and the graphical loss zone based on the at least one strike price selector; dynamically and without user input retrieving updated market data associated with the at least one contract from a computer server external to the computer system; and responsive to the updated market data associated with the at least one contract, regenerating the dynamic visualization interface to restrict movement of the at least one strike price selector to a subset of the plurality of increasing prices based on the updated market data.

According to some embodiments described herein, a computer program product for electronically visualizing contracts includes a non-transitory computer readable storage medium having computer readable program code embodied in the medium that when executed by at least one processor causes the at least one processor to perform operations including: generating a dynamic visualization interface for display on a computer system, the dynamic visualization interface including: a plurality of indicia of selection, respective ones of the plurality of indicia of selection corresponding to variables associated with at least one contract; a plurality of increasing numbers corresponding to one or more of the plurality of indicia of selection; and a graphical indication that indicates a plurality of magnitudes of values that are dependent on the indicia of selection; monitoring one or more input devices of the computer system for adjustment to the one or more of the plurality of indicia of selection; and responsive to the adjustment to the indicia of selection, regenerating the dynamic visualization interface to reconfigure the graphical indication to adjust respective ones of the plurality of magnitudes of the values for respective ones of the plurality of increasing numbers.

In some embodiments, the plurality of increasing numbers corresponds to a plurality of prices, respectively, associated with an underlying asset of the at least one contract.

In some embodiments, the plurality of indicia of selection includes a strike price selector for the at least one contract.

In some embodiments, the plurality of magnitudes of values includes a value of a profit and/or a loss for the at least one contract based on a strike price indicated by the strike price selector and based on ones of the plurality of increasing numbers.

In some embodiments, respective ones of the plurality of magnitudes of values are automatically and dynamically adjusted based on a market price of an underlying asset of the at least one contract that is retrieved over an electronic network.

In some embodiments, monitoring the one or more input devices of the computer system for the adjustment to the one or more of the plurality of indicia of selection includes: detecting a selection, via a user input of the computer system, of an indicium of selection of the plurality of indicia of selection at a first position in the dynamic visualization interface; and detecting a movement, via the user input of the computer system, of the indicium of selection of the plurality of indicia of selection to a second position in the dynamic visualization interface.

In some embodiments, the adjustment of the strike price selector of the at least one contract is limited to a subset of the plurality of increasing numbers based on available prices of the at least one contract.

In some embodiments, the subset of the plurality of increasing numbers is a first subset, the strike price selector is a first indicium of selection, the adjustment of the first indicium of selection is a first adjustment, and, responsive to a second adjustment of a second indicium of selection of the plurality of indicia of selection, a third adjustment of the first indicium of selection is limited to a second subset of the plurality of increasing numbers, different than the first subset.

In some embodiments, the adjustment of the strike price selector includes movement in a first direction of a graphical element of the dynamic visualization interface, and the graphical element extends in a second direction, crossing the first direction.

In some embodiments, the at least one contract includes a first contract and a second contract, a first indicium of selection of the plurality of indicia of selection is a first strike price selector corresponding to the first contract, and a second indicium of selection of the plurality of indicia of selection is a second strike price selector corresponding to the second contract.

In some embodiments, the plurality of magnitudes of values includes a value of a combined profit and/or a combined loss for the first contract and the second contract, and the value is based on a first strike price indicated by the first strike price selector and a second strike price indicated by the second strike price selector.

In some embodiments, the plurality of increasing numbers is adjacent the graphical indication that indicates the plurality of magnitudes of values within the dynamic visualization interface.

In some embodiments, the plurality of increasing numbers corresponds to a plurality of prices, respectively, associated with the at least one contract, and a respective one of the plurality of magnitudes of values includes a value of a profit or a loss of the at least one contract based on a strike price indicated by the strike price selector and based on a price of the plurality of prices that is adjacent the respective one of the plurality of magnitudes of values.

In some embodiments, the respective one of the plurality of magnitudes of values includes a first color that indicates the loss associated with the at least one contract or a second color that color indicates the profit associated with the at least one contract.

In some embodiments, the graphical indication is a polygon that is adjacent the plurality of increasing numbers.

According to some embodiments described herein, a computer-implemented method for electronically visualizing contracts, includes: generating a dynamic visualization interface for display on a computer system, the dynamic visualization interface including: a plurality of indicia of selection, respective ones of the plurality of indicia of selection corresponding to variables associated with at least one contract; a plurality of increasing numbers corresponding to one or more of the plurality of indicia of selection; and a graphical indication that indicates a plurality of magnitudes of values that are dependent on the indicia of selection; monitoring one or more input devices of the computer system for adjustment to the one or more of the plurality of indicia of selection; and responsive to the adjustment to the indicia of selection, regenerating the dynamic visualization interface to reconfigure the graphical indication to adjust respective ones of the plurality of magnitudes of the values for respective ones of the plurality of increasing numbers.

In some embodiments, the plurality of increasing numbers corresponds to a plurality of prices, respectively, associated with an underlying asset of the at least one contract.

In some embodiments, the plurality of indicia of selection includes a strike price selector for the at least one contract.

In some embodiments, the plurality of magnitudes of values includes a value of a profit and/or a loss for the at least one contract based on a strike price indicated by the strike price selector and based on ones of the plurality of increasing numbers.

In some embodiments, respective ones of the plurality of magnitudes of values are automatically and dynamically adjusted based on a market price of an underlying asset of the at least one contract that is retrieved over an electronic network.

In some embodiments, monitoring the one or more input devices of the computer system for the adjustment to the one or more of the plurality of indicia of selection includes: detecting a selection, via a user input of the computer system, of an indicium of selection of the plurality of indicia of selection at a first position in the dynamic visualization interface; and detecting a movement, via the user input of the computer system, of the indicium of selection of the plurality of indicia of selection to a second position in the dynamic visualization interface.

In some embodiments, the adjustment of the strike price selector of the at least one contract is limited to a subset of the plurality of increasing numbers based on available prices of the at least one contract.

In some embodiments, the subset of the plurality of increasing numbers is a first subset, the strike price selector is a first indicium of selection, the adjustment of the first indicium of selection is a first adjustment, and, responsive to a second adjustment of a second indicium of selection of the plurality of indicia of selection, a third adjustment of the first indicium of selection is limited to a second subset of the plurality of increasing numbers, different than the first subset.

In some embodiments, the adjustment of the strike price selector includes movement in a first direction of a graphical element of the dynamic visualization interface, and the graphical element extends in a second direction, crossing the first direction.

In some embodiments, the at least one contract includes a first contract and a second contract, a first indicium of selection of the plurality of indicia of selection is a first strike price selector corresponding to the first contract, and a second indicium of selection of the plurality of indicia of selection is a second strike price selector corresponding to the second contract.

In some embodiments, the plurality of magnitudes of values includes a value of a combined profit and/or a combined loss for the first contract and the second contract, and the value is based on a first strike price indicated by the first strike price selector and a second strike price indicated by the second strike price selector.

In some embodiments, the plurality of increasing numbers is adjacent the graphical indication that indicates the plurality of magnitudes of values within the dynamic visualization interface.

In some embodiments, the plurality of increasing numbers corresponds to a plurality of prices, respectively, associated with the at least one contract, and a respective one of the plurality of magnitudes of values includes a value of a profit or a loss of the at least one contract based on a strike price indicated by the strike price selector and based on a price of the plurality of prices that is adjacent the respective one of the plurality of magnitudes of values.

In some embodiments, the respective one of the plurality of magnitudes of values includes a first color that indicates the loss associated with the at least one contract or a second color that color indicates the profit associated with the at least one contract.

In some embodiments, the graphical indication is a polygon that is adjacent the plurality of increasing numbers.

It is noted that aspects of the inventive concepts described with respect to one embodiment, may be incorporated in a different embodiment although not specifically described relative thereto. That is, all embodiments and/or features of any embodiment can be combined in any way and/or combination. Other operations according to any of the embodiments described herein may also be performed. These and other aspects of the inventive concepts are described in detail in the specification set forth below.

### BRIEF DESCRIPTION OF THE DRAWINGS

The above and other objects and features will become apparent from the following description with reference to the following figures, wherein like reference numerals refer to like parts throughout the various figures unless otherwise specified.

FIG. 1 illustrates a dynamic visualization interface that provides data visualization for complex market strategies, according to embodiments described herein.

FIG. 2 illustrates the dynamic visualization interface of FIG. 1 after being modified by a user, according to embodiments described herein.

FIG. 3 illustrates a mechanism to adjust a variable of an option contract within the dynamic visualization interface, according to embodiments described herein.

FIG. 4 illustrates an additional method to alter data with the dynamic visualization interface, according to embodiments described herein.

FIG. 5 illustrates a dynamic visualization interface involving three different option contracts with three different strike prices, according to embodiments described herein.

FIG. 6 illustrates a dynamic visualization interface in which four different option contracts are combined, with four separate strike prices, to form a particular option contract strategy, according to embodiments described herein.

FIG. 7 illustrates that alternate dynamic visualization interface, according to various embodiments described herein.

FIG. 8 an embodiments of the dynamic visualization interface for other types of option contract strategies involving three contracts, according to various embodiments described herein.

FIG. 9 an embodiments of the dynamic visualization interface for other types of option contract strategies involving four contracts, according to various embodiments described herein.

FIG. 10 illustrates a device for implementing the dynamic visualization interfaces, according to various embodiments described herein.

FIG. 11 illustrates embodiments of process configured to provide the dynamic visualization interface, according to various embodiments described herein.

FIG. 12 illustrates additional embodiments of a process configured to provide a dynamic visualization interface, according to various embodiments described herein.

FIG. 13 illustrates additional embodiments configured to detect a change in the indicia of selection discussed with respect to FIG. 12, according to various embodiments described herein.

FIG. 14 illustrates various embodiments configured to move the indicia of selection within the dynamic visualization interface discussed with respect to FIG. 12, according to various embodiments described herein.

### DETAILED DESCRIPTION

Advantages and features of the present disclosure and methods of accomplishing the same may be understood more readily by reference to the following detailed description of example embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the present disclosure to those skilled in the art. Like reference numerals refer to like elements throughout the specification.

As appreciated by the present inventors, current data visualization models for market transactions lack the ability to display cohesive sets of information on a single scale. With some complicated transactions, there may be multiple data points, such as prices, durations, volumes, and gain/loss, each of which may be interdependent on the other values. Changing one variable data point may change all of the others, making it difficult for a user to track the effects of particular changes and to plan strategically.

One type of market transaction is an option. Option contracts may be made for many assets, such as, for example, stocks, bonds, market indices, commodities, etc. With respect to the stock market, an option is a contract allowing a buyer/seller to purchase a particular number of stock shares at a particular price or sell a particular number of stock shares a particular price. The value of the option may vary as the current market price of the stock changes with respect to the price indicated in the option contract, known as the strike price. For example, the value of an option to purchase a share of stock with a strike price of $14 increases as the market price of the stock share increases above $14. If the market price of the stock is $16, the owner of the $14 option has the right to buy something (the stock) worth $16 for only $14, thus realizing a $2 value.

Similarly, the value of the option may decrease, or become zero, when the market price of the stock is below a strike price. For example, if the market price of the stock is $12, then an option contract to purchase stock with a strike price of $14 has no value, since the owner of the option contract could buy the stock more cheaply at the market price than the strike price.

For every person that has an option contract to buy a stock at a particular price, there is another party to the option contract that has an obligation to sell the stock at the contracted price. As a result, an option contract which may be a gain for one party, is likely a loss for the other party. As in the example discussed above, a party with an obligation to sell a share of stock at $14 may lose value of $2 if the option contract is exercised when the market price of the stock is $16, since the party could have sold the stock for more on the open market.

As noted above, the risk associated with a particular option contract varies as the market price of the stock changes. Accordingly, parties to option contract may buy additional option contracts to hedge against risk. For example, if a first option contract loses money when the price of a stock rises, a second option contract may be purchased that will gain money when the price of the stock rises. Thus the investor might be covered in any eventuality. These sorts of hedging strategies may involve a first option contract directed to buying/selling a stock at a first price, and a second option contract directed to buying/selling the stock at a second price, different from the first price.

Similarly, certain option contracts gain more value when a particular stock is less volatile, meaning that the stock price does not change beyond a particular amount. To hedge against risk, a second option contract might be purchased which gains more value when the same stock is more volatile.

Option contracts may have a price associated with them above the price of the stock. That is to say that a particular investor may pay an additional amount for the right to purchase the contract. Option contracts may also have expiration dates over which the option contract may be exercised. The expiration date may indicate the last date on which a particular strike price can be exercised. The length of the expiration date may affect the overall value of the option contract. For example, an expiration date far in the future may cost more for a buyer to acquire because it exposes the seller to risk that the underlying price of the stock will change over a longer period of time.

The use of multiple option contracts for a particular underlying asset e.g., stock, commodity, etc.) is a strategy against overall risk. The individual option contracts which support the strategy may be known as “legs” of the contract.

One problem for investors is that it is difficult to see, in a single place, not only the various legs of an option contract strategy, but also how those various legs contribute to the overall risk of the strategy, as well as how that risk changes as the variables related to the legs of the option contract are changed.

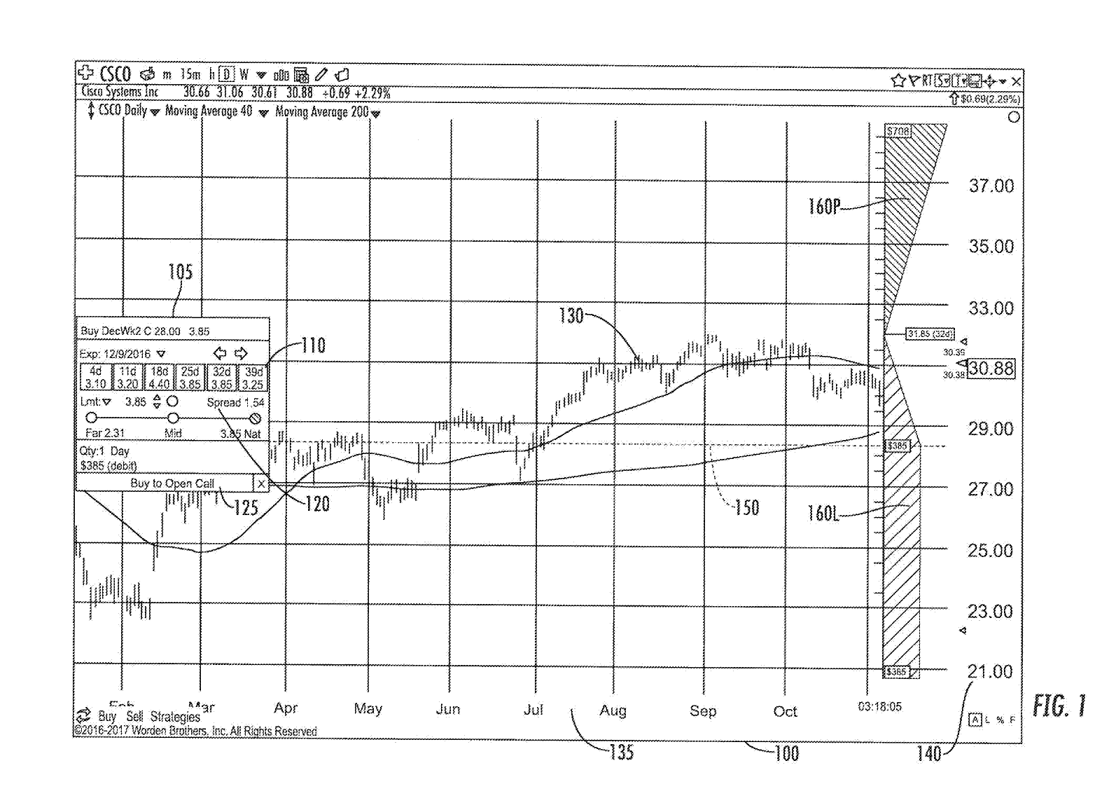

FIG. 1 illustrates a dynamic visualization interface that provides data visualization for complex market strategies.

As illustrated in FIG. 1, a dynamic visualization interface 100 may display multiple variables related to a particular option contract strategy for a given stock. The overall strategy being contemplated may be displayed in an option command interface 105. The option command interface 105 may display multiple variables that may be modified with respect to a particular option contract.

For example, the option command interface 105 may illustrate a contemplated expiration date 110 for the option contract. As discussed herein, altering the expiration date 110 of the option contract may alter the price demanded of the option contract.

The option command interface 105 may also illustrate a price strategy 120 for the underlying option. The price strategy 120 may indicate whether the option contract strategy being analyzed will be offered by the user of the dynamic visualization interface 100 at the existing market price or for some price greater or lesser than the existing market price.

The option command interface 105 may also contain an input element 125 to execute a market order for the given option contract. A user may use the option command interface 105 to construct an option contract that is acceptable to the user and then select the input element 125 to execute a trade to acquire the contract.

The dynamic visualization interface 100 may further illustrate current performance history 130 of the stock. The performance history 130 of the stock may include past prices, volumes, trends, differences between offered and accepted prices, etc. One of skill in the art will recognize that a rich set of performance indicators may make up the performance history 130.

The performance history 130 of the stock may be illustrated with respect to a time axis 135 (e.g., the X axis) and a price axis 140 (e.g., the Y axis). The time axis 135 may provide an indicator of which point in time corresponds to the illustrated performance history 130.

The price axis 140 may illustrate a common reference for the performance history 130. That is to say that, because a price of a stock is an important variable in option contracts, the price axis 140 provides a series of relative reference values to which the performance history 130 may be compared.

A user of the dynamic visualization interface 100 may use the dynamic visualization interface 100, in conjunction with the option command interface 105 to visualize particular option contracts. In some embodiments, the user of the dynamic visualization interface 100 may adjust variables of the option contract and dynamically see their results on the dynamic visualization interface 100.

For example, as noted above, a relative value of an option contract may depend both on the current market price and the strike price of the option contract. Thus, an important decision point for a potential purchaser of an option contract may be how valuable the option contract would be, for a given strike price, if the underlying market value of the stock were to change.

The dynamic visualization interface 100 illustrates the relative value for a given change in underlying market price of the stock via profit zones 160P and loss zones 160L. Since these profit and loss zones 160P/160L depend at least partly on the underlying strike price of the option contract, the dynamic visualization interface 100 may include a strike price indicator 150. That is to say that, for a given contemplated option contract, the profit and loss zones 160P/160L may depict the relative gain or loss that would be realized as the market price for the underlying stock changes. As illustrated in FIG. 1, the magnitude of the profit (or loss) of the contract for a given price on the price axis 140 may be indicated by a width of the profit zone 160P or loss zone 160L at that price. The profit zones 160P and loss zones 160L may be differentiated from one another by color or other indicator, such as shading, texture, size, etc., within the dynamic visualization interface 100.

The price indicator 150, the contemplated expiration date 110, and/or the price strategy 120 elements discussed herein are examples of indicia of selection within the dynamic visualization interface 100 that may be modified by the user to portray various dependent relationships within the underlying option contract. Because a particular gain or loss depicted by the profit and loss zones 160P/160L may be dependent on the indicia of selection, modifications made to the indicia of selection by the user may alter the profit and loss zones 160P/160L.

For example, referring to FIG. 1, the dynamic visualization interface 100 illustrates a simple option contract for the right to buy a particular stock at a particular price, known as a “call.” The graph indicates a contemplated option contract for the right to buy the stock at $28. As can be seen, the dynamic visualization interface 100 displays the strike price indicator 150 as a horizontal dashed line, though the present inventive concepts are not limited thereto. As discussed herein, the price of the stock would have to rise above the strike price, shown by the strike price indicator 150, before the option contract would have value. However, such a simple view of the value of the option contract does not take into account the cost of the option contract itself. Thus, the dynamic visualization interface 100 displays profit and loss zones 160P/160L that do not indicate a positive value (where a magnitude of the profit zone 160P is greater than zero) until the market price of the stock rises above $31.85. This is the break-even point for this particular option contract taking into account current market data. A user of the dynamic visualization interface 100 may follow the price axis 140 up to a particular market price of the stock, and then examine the portion of the profit and loss zones 160P/160L corresponding to that price on the price axis 140 to determine the relative value (e.g., profit or loss) of the option contract at that market price.

As can be seen in FIG. 1, the value of the particular option contract illustrated in FIG. 1 increases linearly as the market price of the stock exceeds the break-even point. Similarly, the value of the option decreases below the break-even point. However, the value does not decrease linearly indefinitely for this particular option because, as discussed herein, the purchaser of the option contract may simply opt not to exercise the contract if the price is below the strike price. Thus, for this particular type of contract, the loss may be bounded by the overall price of the contract itself.

One advantage of the dynamic visualization interface 100 is that it illustrates much of the relevant data for a particular option contract on a single graph and on a single price axis 140 using profit and loss zones 160P/160L. Thus a purchaser can dynamically see those variables which may be of greatest value in determining an option contract strategy.

Though the profit and loss zones 160P/160L are illustrated as various polygons within the figures, it will be understood that multiple shapes and or methods may be utilized to display the relative gain or loss against a common price axis 140 without deviating from the present inventive concepts. For example, other shapes such as curves or lines may be used. The scale for the price axis 140 profit and loss zones 160P/160L may be linear, but may also be logarithmic or percentage-based. In addition to shapes, lines, shading, colors, or other mechanisms may be used to illustrate the profit and loss zones 160P/160L. In some embodiments, a heat map may be used to illustrate the profit and loss zones 160P/160L.

Moreover, a user of the dynamic visualization interface 100 may wish to change and interact with values to determine the best option contract strategy. Such interaction may involve changing variables of the option contract such as strike price, contract expiration, etc.

In addition, the dynamic visualization interface 100 may also display the current information for both the underlying stock and the possible option contracts based on current market information. To provide this information, the dynamic visualization interface 100 may dynamically retrieve data related to the stock and its available option contracts via a network or other communication mechanism. For example, the dynamic visualization interface 100 may access a network adapter to communicate with a separate server to retrieve market data related to the options contracts and the underlying stock. Based on the updated market data that is retrieved, the dynamic visualization interface 100 may be automatically and dynamically updated to display the current market data associated with the underlying stock or other asset being displayed by the dynamic visualization interface 100.

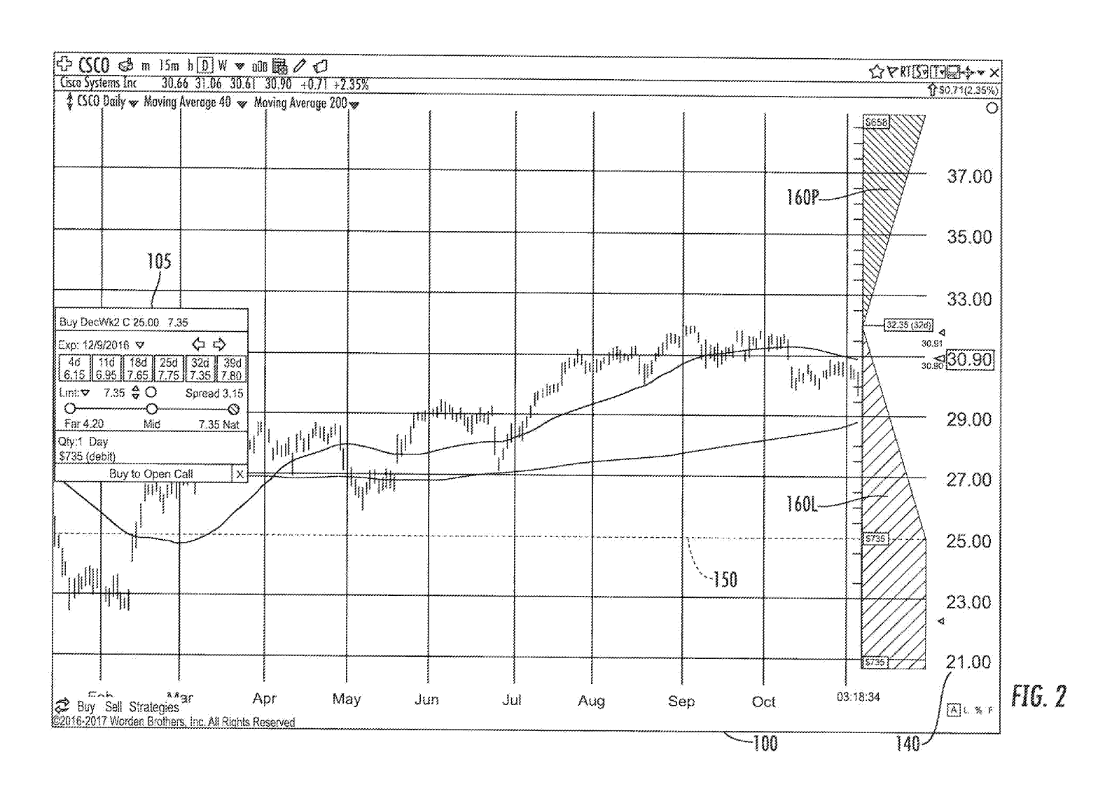

FIG. 2 illustrates the dynamic visualization interface of FIG. 1 after being modified by a user. Referring now to FIG. 2, the dynamic visualization interface 100 is illustrated after the strike price indicator 150 has been changed by the user of the dynamic visualization interface 100. In this example, the user of the dynamic visualization interface 100 has changed the strike price for a potential option contract from $28 to $25. As illustrated in the dynamic visualization interface 100 of FIG. 2, the strike price indicator 150 may be moved within the dynamic visualization interface 100 to display the new strike price for the contemplated option contract, and the profit and loss zones 160P/160L may be similarly changed. Because the strike price of the option may change, the possible gains and losses for given market prices of the underlying stock may change as well. In this way, the dynamic visualization interface 100 quickly displays, on a single price axis 140, the impact of a change in the contemplated contract.

In addition to the modifications in the dynamic visualization interface 100 related to changes selected by the user of the dynamic visualization interface 100, the dynamic visualization interface 100 may also dynamically display changes related to current market conditions. For example, as the current market price of the underlying stock changes, so too will the asking price for the underlying option contracts. In some embodiments, the dynamic visualization interface 100 may retrieve these changes dynamically by polling, or otherwise retrieving, market data (e.g., real-time data) via a network connection to an external server. As a result, the profit and loss zones 160P/160L may change dynamically and/or automatically for the user even if the user has not directly changed an input. As used herein, automatic, or automatically, may include operations that are performed by a computer system without requiring explicit input from a user. Thus, the user of the dynamic visualization interface 100 will have a current view of accurate profit and loss zones 160P/160L before making a decision on whether or not to purchase the option contract. That is to say that the profit and loss zones 160P/160L may reflect the magnitude of risk associated with a particular option strategy based on current market conditions and/or the selected characteristics of the option strategy itself (e.g., price, expiration, etc.).

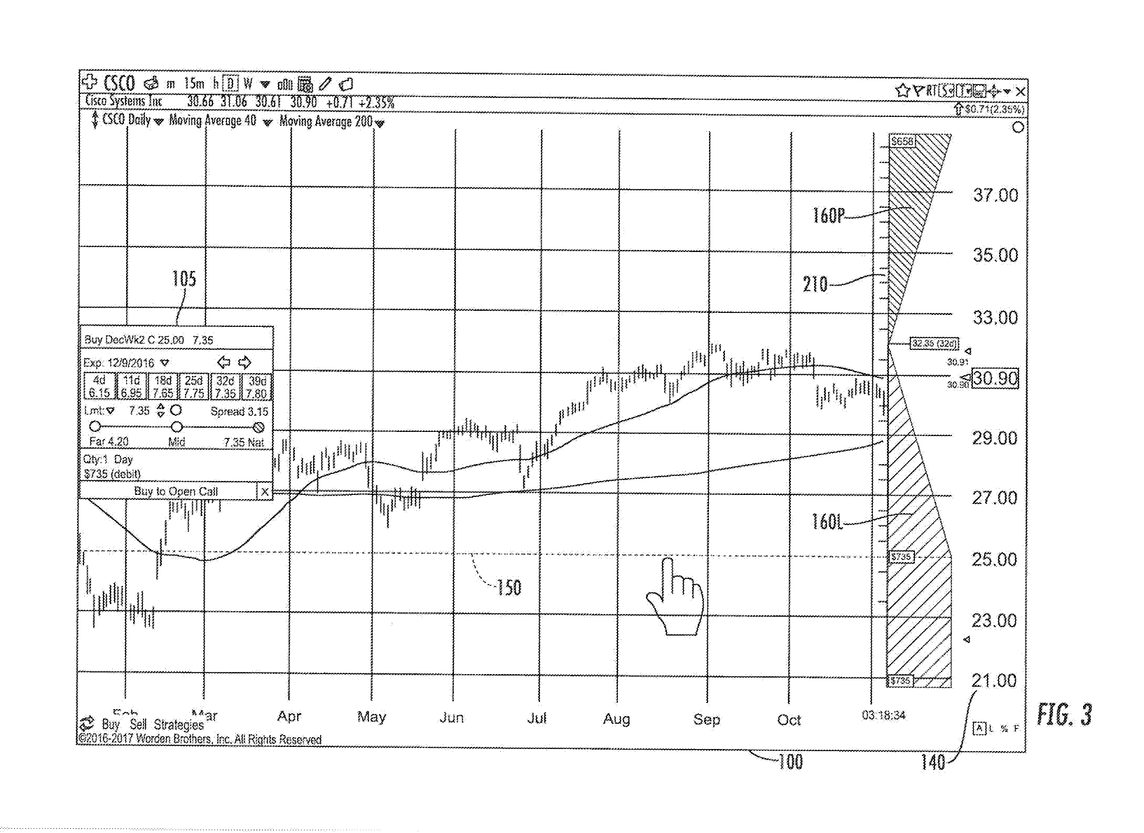

FIG. 3 illustrates a mechanism to adjust a variable of the option contract within the dynamic visualization interface 100. As illustrated in FIG. 3, in some embodiments, the dynamic visualization interface 100 may allow the user to dynamically adjust the strike price of the option contract by altering the strike price indicator 150. In some embodiments, this may be done by the user via a mouse operation in which the strike price indicator 150 is clicked upon and dragged to the user's preferred strike price. As will be understood by one of skill in the art, multiple user interface options may be leveraged within the dynamic visualization interface 100 to dynamically move the strike price indicator 150. For example, the user may use a touch screen to drag the strike price indicator 150.

In some embodiments, the dynamic visualization interface 100 may limit the prices to which the strike price indicator 150 may be moved. For example, as illustrated in FIG. 3, the dynamic visualization interface 100 may have hash marks 210 which illustrate to which prices on the price axis 140 the strike price indicator 150 may be moved. Such a control element may be used because option contracts are, in some instances, only offered at particular strike prices. That is to say that in some embodiments a user of the dynamic visualization interface 100 may not be able to pick from any theoretical strike price but may be limited to those strike prices that are available in the market. In some embodiments the hash marks 210 may visually indicate which option prices are available in the market.

In order to correctly display the hash marks 210, the dynamic visualization interface 100 may dynamically retrieve via a network or other communication mechanism the available option contracts for the stock selected by the user. The dynamic visualization interface 100 may enforce the selection of an available price by restricting the movement of the strike price indicator 150 to move only from one hash mark 210 to another hash mark 210.

In some embodiments, if a user of the dynamic visualization interface 100 alters a selection within the dynamic visualization interface 100 that changes the availability of option contracts, the presentation of the hash marks 210 may change. For example, the hash marks 210 may become fewer and further apart and or greater and closer together. Though illustrated as being uniform in distribution, it will be understood that the hash marks 210 may be arranged in a non-uniform manner. That is to say that the price indicator 150 may move in non-uniform increments when moving from one hash mark 210 to another hash mark 210.

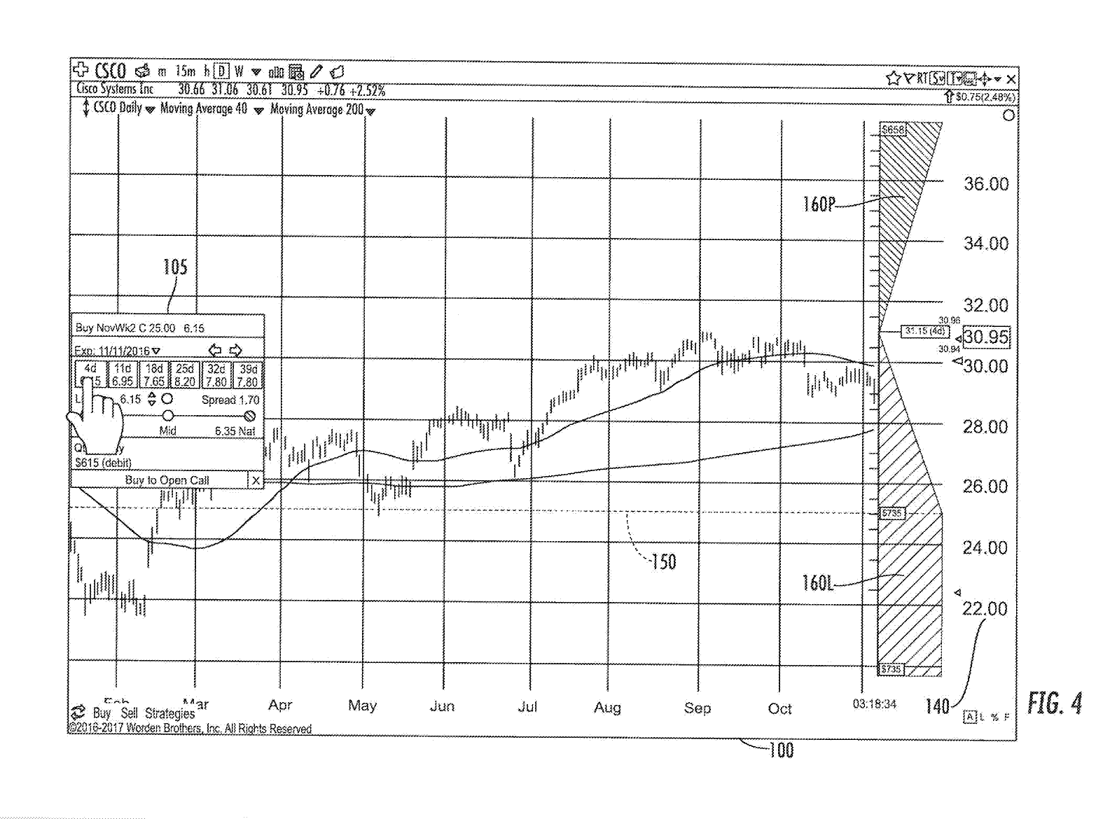

Beyond dragging the strike price indicator 150, other options are available to the user to modify data pertaining to the option contract. FIG. 4 illustrates an additional method to alter data with the dynamic visualization interface 100.

As illustrated in FIG. 4, a user of the dynamic visualization interface 100 may also utilize controls within the option command interface 105 to alter data associated with the option contract displayed in the dynamic visualization interface 100. For example, as shown in FIG. 4, the user may utilize an input device (e.g., keyboard, mouse, and/or touch screen) associated with the dynamic visualization interface 100 to change the expiration date of a given contract. By selecting a different expiration date for the contract, the profit and loss zones 160P/160L may automatically adjust to correctly display the projected profit and loss for a particular option contract corresponding to a given market price on the price axis 140. As with other elements of the dynamic visualization interface 100, the various expiration dates of the contracts available, as well as their respective prices, may be dynamically queried by the dynamic visualization interface 100 so that current information is updated within the option command interface 105 to represent the current market conditions.

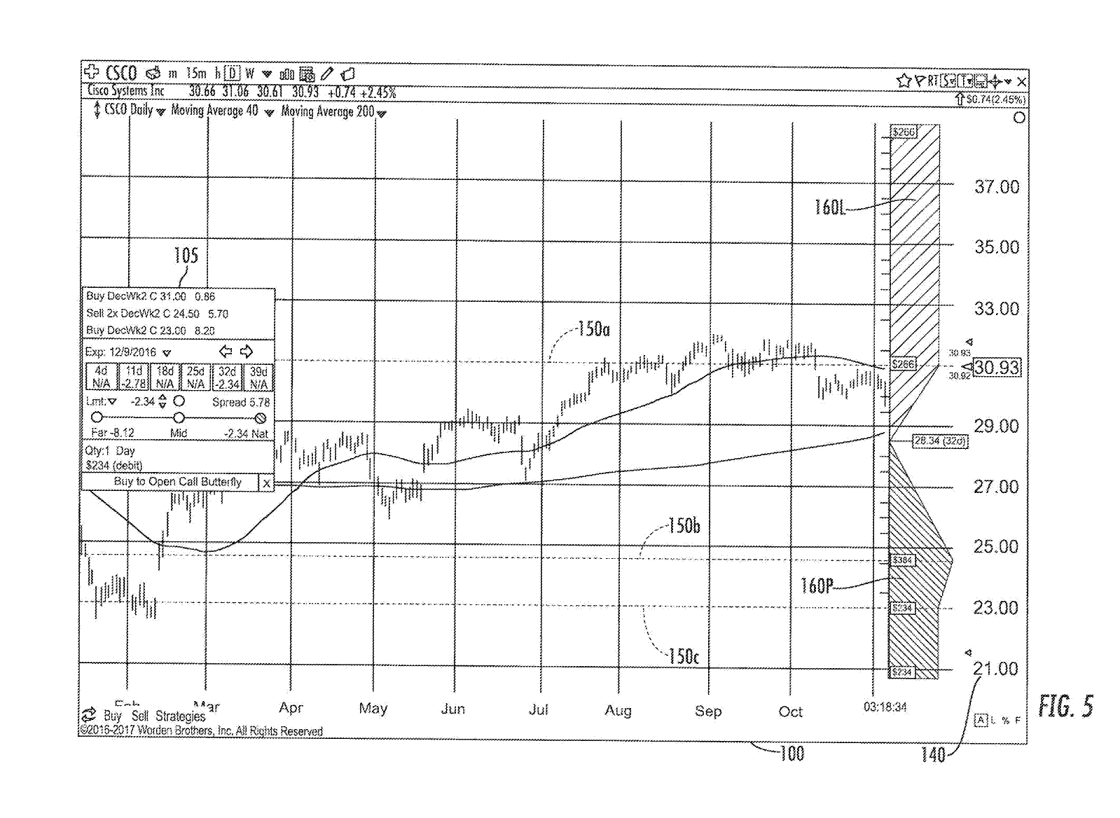

Though FIGS. 1-4 illustrate option contracts with single strike prices, it is possible, as discussed herein, to have option contracts with multiple strike prices. In some embodiments, one or more option contracts for the underlying asset (e.g., stock, index, bond, commodity, etc.) may be combined to hedge against risk. In such embodiments, different strike prices may be associated with different legs of the option contract strategy. For example, in some embodiments, as illustrated in FIG. 5, an option contract strategy may involve three different option contracts with three different strike prices for a given asset. The different strike prices may be illustrated within the dynamic visualization interface 100 by a first strike price indicator 150a, a second strike price indicator 150b, and a third strike price indicator 150c. Within the dynamic visualization interface 100, each of the three strike price indicators 150a, 150b, 150c may be individually manipulated to formulate an option contract strategy. Responsive to the changing of the various strike prices, the dynamic visualization interface 100 may further dynamically adjust the profit and loss zones 160P/160L to correctly indicate the potential value for the underlying option contracts at various market prices of the underlying stock as indicated by the common price axis 140. That is to say that the profit and loss zones 160P/160L may reflect the gain and loss of all the option contracts (i.e. all the legs) of the selected option strategy combined into a single gain/loss value. As illustrated in the particular option contract strategy selected in FIG. 5, the value of the option contracts selected is greater at lower stock prices and lesser and/or negative at higher prices of the stock.

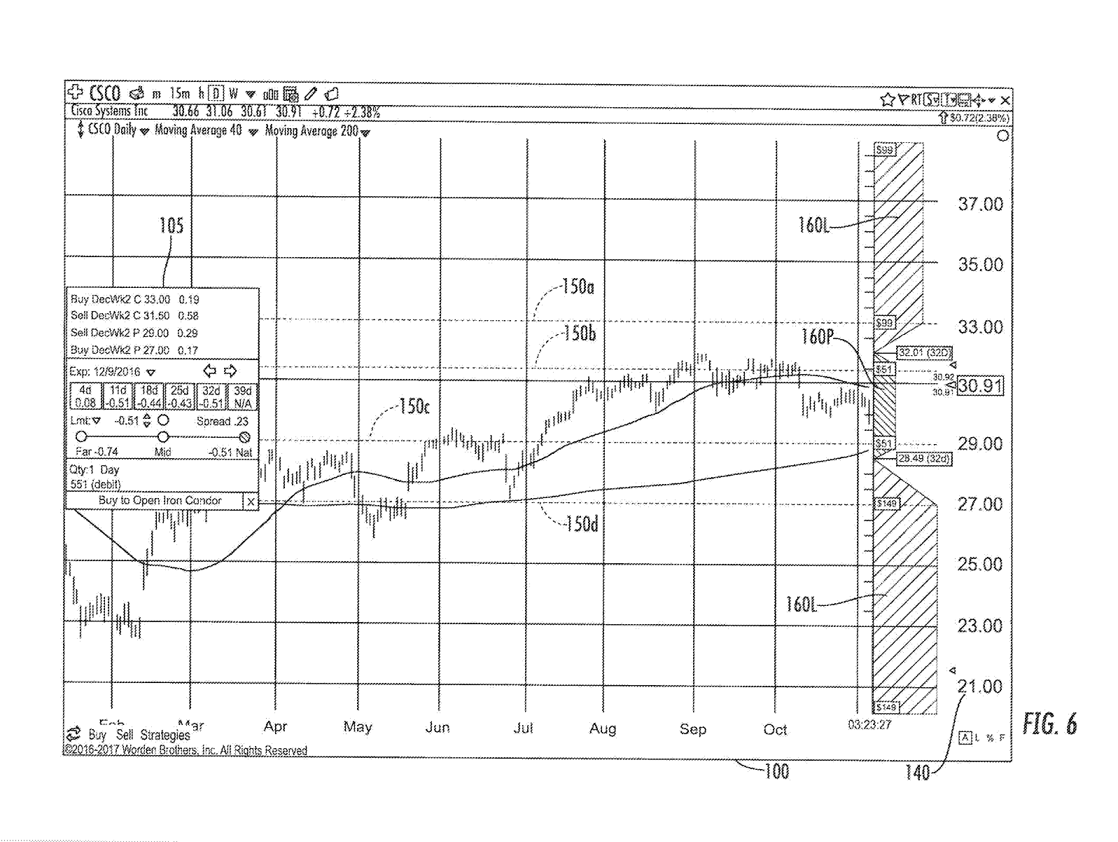

FIG. 6 illustrates yet another example in which four different option contracts are combined, with four separate strike prices, to form a particular option contract strategy. The different strike prices may be illustrated within the dynamic visualization interface 100 by a first strike price indicator 150a, a second strike price indicator 150b, a third strike price indicator 150c, and a fourth strike price indicator 150d. Within the dynamic visualization interface 100, each of the four strike price indicators 150a, 150b, 150c, 150d may be individually manipulated to formulate the option contract strategy. Responsive to the user changing the various strike prices, the dynamic visualization interface 100 may further dynamically adjust the profit and loss zones 160P/160L to correctly indicate the potential value for the underlying option contracts at various market prices of the underlying stock as indicated by the common price axis 140. As illustrated in the particular option contract strategy selected in FIG. 6, the value of the option contracts selected will be positive if the future value of the stock is relatively stable, but lesser and/or negative the more the price of the stock rises or falls.

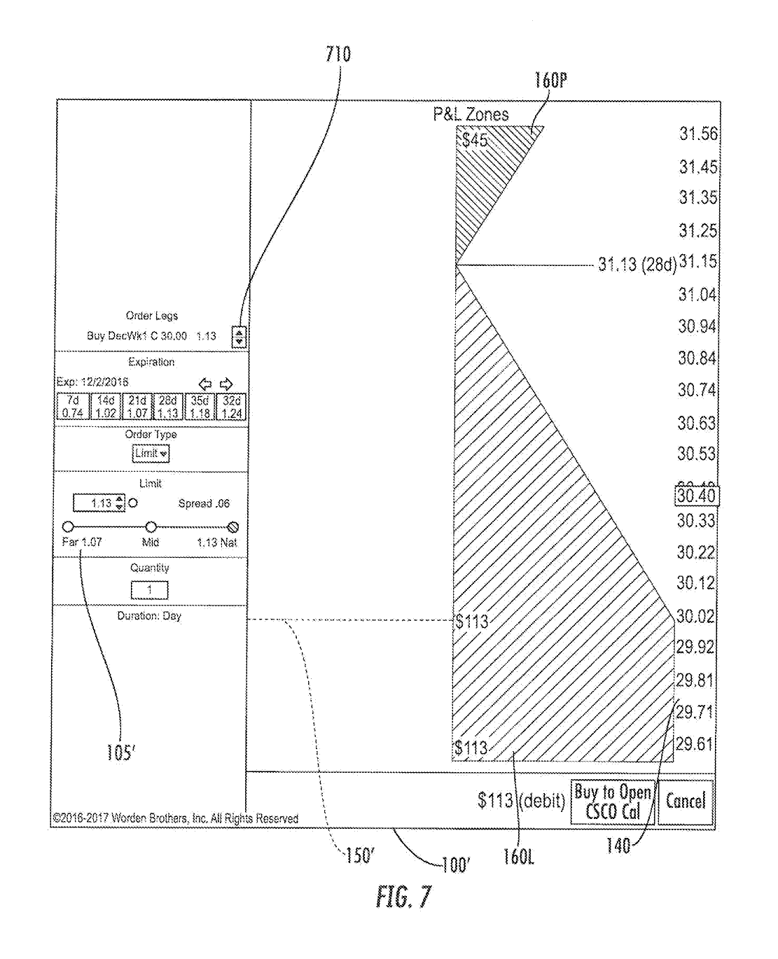

FIG. 7 illustrates that alternate interfaces are available for a dynamic visualization interface 100′ without deviating from the present inventive concepts. As illustrated in FIG. 7 the dynamic visualization interface 100′ may contain an option command interface 105′ similar to that of FIG. 1. In some embodiments, the option command interface 105′ may contain additional controls, such as controls 710 to control a strike price indicator 150′ for altering the strike price of the underlying option contract. The controls 710 may allow the user of the dynamic visualization interface 100′ to alter the strike price in a similar manner as that described with respect to FIG. 3. The controls 710 of the strike price indicator 150′ may be beneficial in confined environments (e.g., portable electronic devices such as tablets and phones) where fine control input devices, such as a mouse, are not available and arrow keys and/or touch screens provide a more useful input mechanism.

In some embodiments of the dynamic visualization interface 100′, the performance history 130 may not be displayed. In some embodiments of the dynamic visualization interface 100′, the time axis 135 may not be displayed. However, as illustrated in FIG. 7, the dynamic visualization interface 100′ may still display the profit and loss zones 160P/160L and the price axis 140. Thus, the user of the dynamic visualization interface 100′ may still see the projected profit and loss zones 160P/160L for the contemplated option contract at future market prices against a common price axis 140.

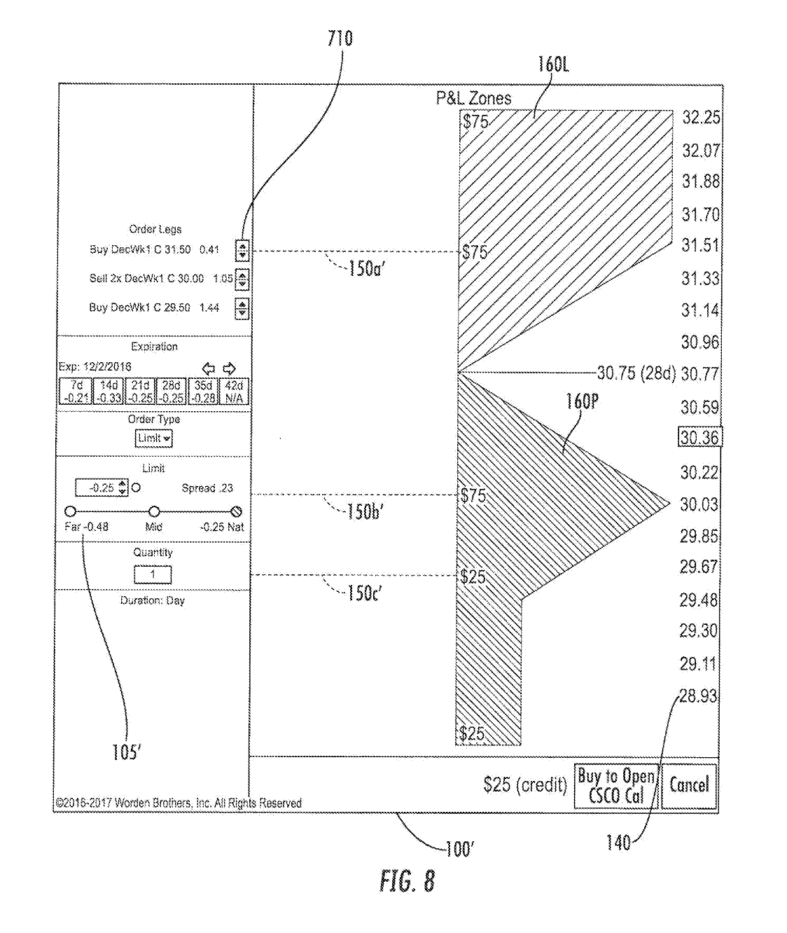

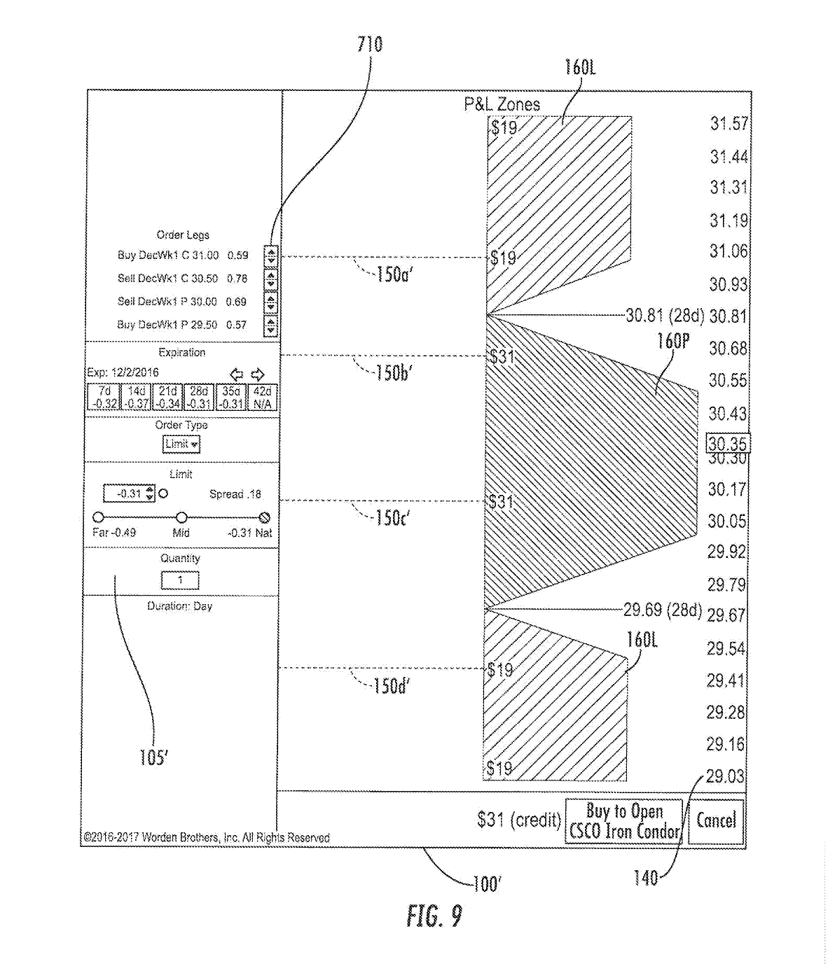

FIGS. 8 and 9 illustrate additional embodiments of the dynamic visualization interface 100′ for other types of option contract strategies involving three contracts (FIG. 8) and four contracts (FIG. 9). These embodiments illustrate additional modifications to the dynamic visualization interface 100′ and additional controls as discussed herein with respect to FIG. 7. Moreover, FIGS. 8 and 9 illustrate multiple strike price indicators 150a′, 150b′, 150c′, and 150d′ for manipulation of multiple strike prices as discussed herein with respect to FIGS. 5-6.

The dynamic visualization interface 100/100′ as described herein provides multiple advantages. For example, the dynamic visualization interface 100/100′ provides a single view of complex option strategies which allow for a decision to be made by a user of the dynamic visualization interface 100/100′ without unnecessary manipulation of the data. By reducing the number of screens needed to visualize the complex data, the dynamic visualization interface 100/100′ reduces the performance overhead required of a computer system implementing complex trades. Moreover, as discussed herein, the dynamic visualization interface 100/100′ further reduces the need for complex input systems. By using less space to support more information, the dynamic visualization interface 100/100′ decreases the computer power and display size needed to determine options strategies. Therefore, the dynamic visualization interface 100/100′ improves the technology used to support trading strategies in a unique and less resource-intensive way.

In addition, the dynamic visualization interface 100/100′ displays dynamically changing data, as well as the potential impact of said data, as the market elements associated with the underlying assets change. This allows an investor to have a consolidated view of multiple contracts, as well as their projected profit/loss points, while the underlying data is rapidly changing due to market conditions. Since the underlying changes in the market conditions can have a broad impact across one, or many, of the contracts being displayed in the dynamic visualization interface 100/100′, the embodiments as described herein provide a single view, using a single axis, in which the impact of the dynamic changes can be projected onto a series of complicated contracts, and the impact of additional changes to the contracts (e.g., various strike prices, expiration dates, etc.) can be evaluated in light of the current market data.

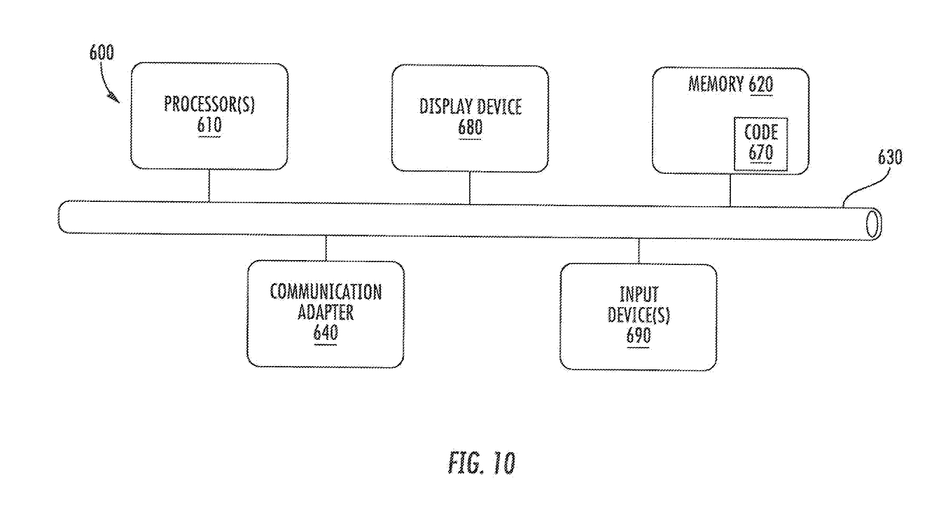

FIG. 10 illustrates a device 600 for implementing the dynamic visualization interfaces 100 and 100′. The device 600 may use hardware, software implemented with hardware, firmware, tangible computer-readable storage media having instructions stored thereon and/or a combination thereof, and may be implemented in one or more computer systems or other processing systems. The device 600 may also utilize a virtual instance of a computer. As such, the devices and methods described herein may be embodied in any combination of hardware and software.

As shown in FIG. 10, the device 600 may include one or more processors 610 and memory 620 coupled to an interconnect 630. The interconnect 630 may be an abstraction that represents any one or more separate physical buses, point to point connections, or both connected by appropriate bridges, adapters, or controllers. The interconnect 630, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (12C) bus, or an Institute of Electrical and Electronics Engineers (IEEE) standard 1394 bus, also called “Firewire”.

The processor(s) 610 may be, or may include, one or more programmable general purpose or special-purpose microprocessors, digital signal processors (DSPs), programmable controllers, application specific integrated circuits (ASICs), programmable logic devices (PLDs), field-programmable gate arrays (FPGAs), trusted platform modules (TPMs), or a combination of such or similar devices, which may be collocated or distributed across one or more data networks. The processor(s) 610 may be configured to execute computer program instructions from the memory 620 to perform some or all of the operations and methods for one or more of the embodiments disclosed herein.

The device 600 may also include one or more communication adapters 640 that may communicate with other communication devices and/or one or more networks, including any conventional, public and/or private, real and/or virtual, wired and/or wireless network, including the Internet. The communication adapters 640 may include a communication interface and may be used to transfer information in the form of signals between the device 600 and another computer system or a network (e.g., the Internet). The communication adapters 640 may include a modem, a network interface (such as an Ethernet card), a wireless interface, a radio interface, a communications port, a PCMCIA slot and card, or the like. These components may be conventional components, such as those used in many conventional computing devices, and their functionality, with respect to conventional operations, is generally known to those skilled in the art.

The device 600 may further include memory 620 which may contain program code 670 configured to execute operations associated with the methods described herein. The memory 620 may include removable and/or fixed non-volatile memory devices (such as but not limited to a hard disk drive, flash memory, and/or like devices that may store computer program instructions and data on computer-readable media), volatile memory devices (such as but not limited to random access memory), as well as virtual storage (such as but not limited to a RAM disk). The memory 620 may also include systems and/or devices used for storage of the device 600.

The program code 670 in the memory 620 may implement technology configured to display and adapt a dynamic visualization interface 100 using methods as described herein. The program code 670 may be configured to access data related to option contracts currently available, process input provided by a user to controls of the dynamic visualization interface 100, and alter a display of the dynamic visualization interface 100 responsive to the market data available and responsive to the user input provided. In some embodiments, the program code 670 may be configured to transmit a message to a server external to the device 600 utilizing the communication adapters 640.

The device 600 may also include input devices 690 such as, but not limited to, a mouse and/or input buttons. The input devices 690 may be accessible to the one or more processors 610 via the system interconnect 630 and may be operated by the program code 670 resident in the memory 620.

The device 600 may also include a display 680 capable of generating a display image of the dynamic visualization interface 100.

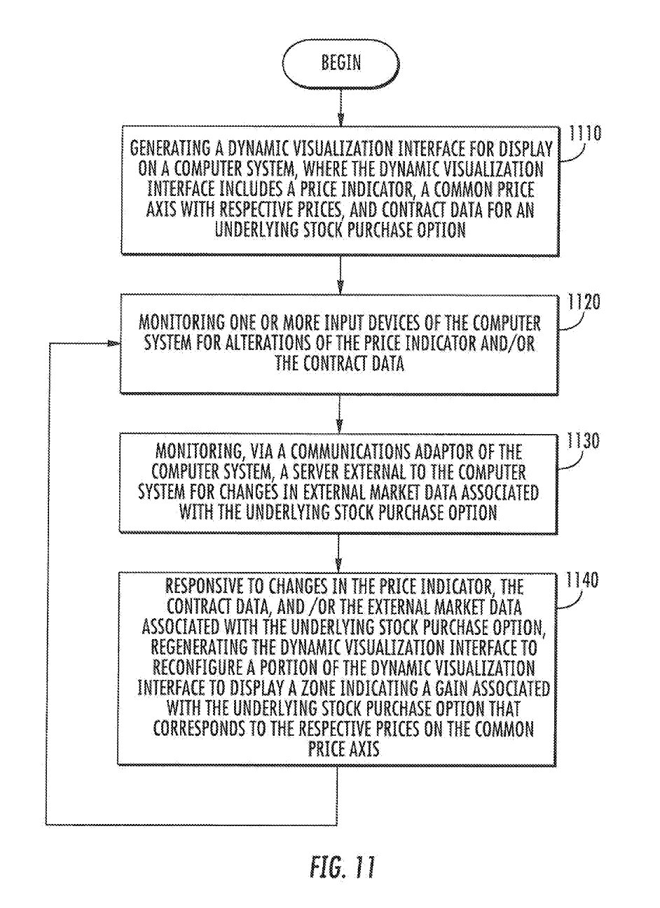

FIG. 11 illustrates embodiments of a process configured to provide the dynamic visualization interface 100. The embodiments may begin at operation 1110, by generating a dynamic visualization interface 100, which may be a graphical control element, for display on a device 600, where the dynamic visualization interface 100 includes a price indicator 150, a common price axis 140 with respective prices, and contract data for an underlying option contract.

The operations may continue at operation 1120 by monitoring input devices 690 of the computer device 600 for alterations of the price indicator 150 and/or the contract data.

The operations may include operation 1130 including monitoring, via a communications adaptor 640 of the device 600, a server external to the device 600 for changes in external market data associated with the underlying option contract.

The operations may continue with operation 1140 by, responsive to changes in the price indicator 150, the contract data, and/or the external market data associated with the underlying option contract, regenerating the dynamic visualization interface 100 to reconfigure a portion of the dynamic visualization interface 100 to display a zone 160P/160L indicating a gain associated with the underlying option contract that corresponds to the respective prices on the common price axis 140.

After execution of operation 1140 the operations may continue by repeating the monitoring steps of operations 1120 and 1130. It will be understood that in some embodiments the monitoring steps of operations 1120 and 1130 may be performed simultaneously or in a different order than presented in the flowchart of FIG. 11.

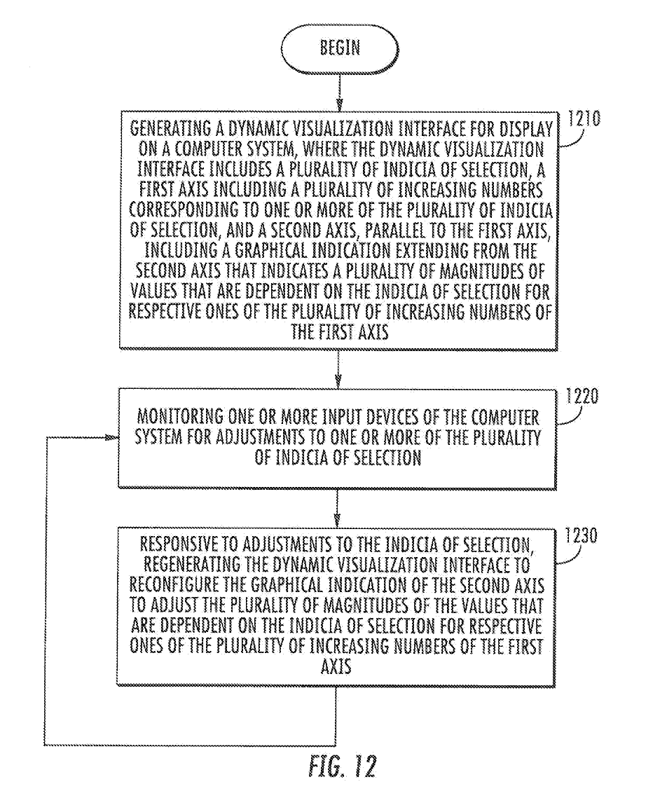

Though illustrated with respect to stock and/or other market contracts, it will be understood that the devices, methods, and computer program products described herein may be used within various environments including, but not limited to, stock/market contracts. For example, FIG. 12 illustrates various embodiments configured to provide a dynamic visualization interface.

The embodiments may begin at operation 1210, by generating a dynamic visualization interface (e.g., dynamic visualization interface 100/100′ described herein) for display on a computer system, where the dynamic visualization interface includes a plurality of indicia of selection, a first axis including a plurality of increasing numbers corresponding to one or more of the plurality of indicia of selection, and a second axis, parallel to the first axis, including a graphical indication extending from the second axis that indicates a plurality of magnitudes of values that are dependent on the indicia of selection for respective ones of the plurality of increasing numbers of the first axis.

In some embodiments, the generation of the dynamic visualization interface described in operation 1210 may be further responsive to other changes within the dynamic visualization interface, such as previous changes in the indicia of selection, and/or other operations performed with the dynamic visualization interface.

In some embodiments, the computer system may be the device 600 illustrated with respect to FIG. 10. The computer system may be a networked server, a personal electronic device, and/or a tablet, though the present inventive concepts are not limited thereto.

In some embodiments, the dynamic visualization interface referred to in FIG. 12 may appear similar the dynamic visualization interface 100/100′ illustrated with respect to FIGS. 1-9. Similarly, the first axis including the plurality of increasing numbers may appear similar to the price axis 140 illustrated with respect to FIGS. 1-9. The first axis may reflect values corresponding to data displayed in the dynamic visualization interface. The indicia of selection may operate to change particular variables related to the data displayed in the dynamic visualization interface. For example, in some embodiments, the indicia of selection may be similar to the expiration date 110, the price strategy 120, and/or the price indicator 150 illustrated with respect to FIGS. 1-9.

The operations may continue at operation 1220 by monitoring one or more input devices of the computer system for adjustments to one or more of the plurality of indicia of selection.

In some embodiments, the one or more input devices may be the input devices 690 illustrated with respect to FIG. 10. For example, the one or more input devices may include a mouse, a tablet, a touch screen, and/or a button, though the present inventive concepts are not limited thereto.

The operations may continue with operation 1230 by, responsive to adjustments to the indicia of selection, regenerating the dynamic visualization interface to reconfigure the graphical indication of the second axis to adjust the plurality of magnitudes of the values that are dependent on the indicia of selection for respective ones of the plurality of increasing numbers of the first axis.

In some embodiments, the plurality of magnitudes of the values that are dependent on the indicia of selection for respective ones of the plurality of increasing numbers of the first axis may be displayed in a format similar to those of the profit and loss zones 160P/160L, discussed herein with respect to FIGS. 1-9. In some embodiments, the magnitudes may extend substantially perpendicular to the second axis. In some embodiments, the first and second axes may be the same axis. That is to say that the plurality of magnitudes may extend from the first axis.

As described with respect to FIGS. 1-9, moving the indicia of selection, (e.g., moving a control such as the price indicator 150) may result in a corresponding change in the magnitudes of the values that correspond to the movement of the indicia of selection. For example, each movement of the price indicator 150 may change magnitudes of a profit zone 160P, a loss zone 160L, or both the profit and loss zones 160P/160L.

After execution of operation 1230 the operations may continue by repeating the monitoring steps of operation 1220.

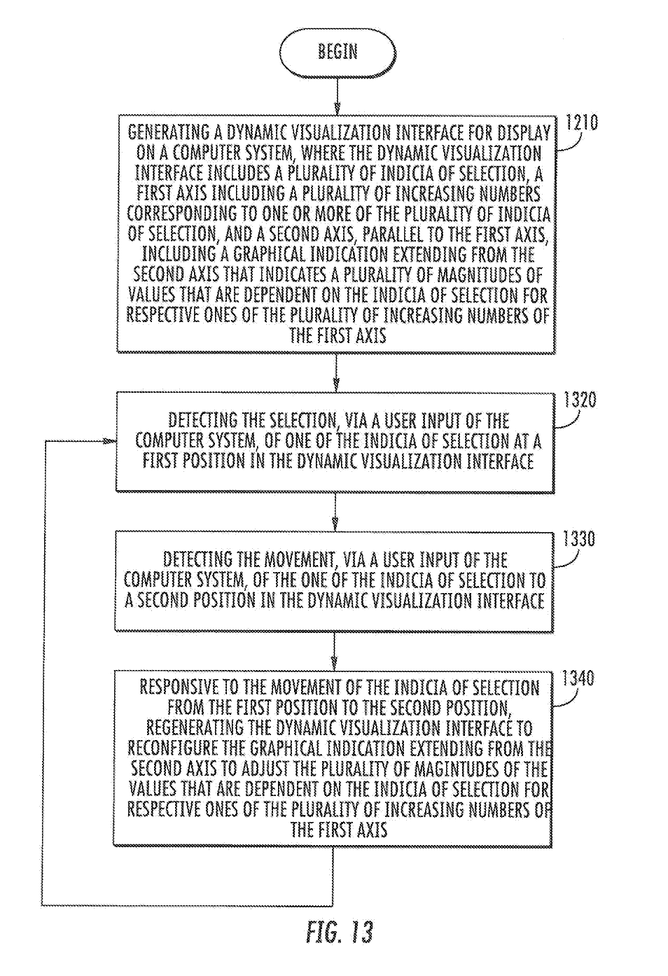

FIG. 13 illustrates additional embodiments configured to detect a change in the indicia of selection discussed with respect to FIG. 12.

The embodiments may begin at operation 1210, discussed herein with respect to FIG. 12. The embodiments may continue with operation 1320, by detecting the selection, via a user input of the computer system, of one of the indicia of selection at a first position in the dynamic visualization interface. As discussed herein, the computer system and the user input referred to with respect to FIG. 13 may be similar to the device 600 and input device(s) 690, respectively, discussed with respect to FIG. 10.

The embodiments may continue with operation 1330, by detecting the movement, via the user input of the computer system, of the one of the indicia of selection to a second position in the dynamic visualization interface.

As discussed herein, movement of the indicia of selection (e.g., movement of the price indicator 150 discussed with respect to FIGS. 1-9) may result in additional changes to the dynamic visualization interface. These changes may be made in operation 1340, in which, responsive to the movement of the indicia of selection from the first position to the second position, the dynamic visualization interface is regenerated to reconfigure the graphical indication extending from the second axis to adjust the plurality of magnitudes of the values that are dependent on the indicia of selection for respective ones of the plurality of increasing numbers of the first axis. This operation is similar to operation 1230 described with respect to FIG. 12. In some embodiments, the reconfiguration of the graphical indication may include calculating and redrawing the graphical indication within the dynamic visualization interface. In some embodiments, this redrawing may be similar to the regeneration of the profit and loss zones 160P/160L discussed herein with respect to FIGS. 1-9.

After operation 1340, the operations may continue with operation 1320, described herein.

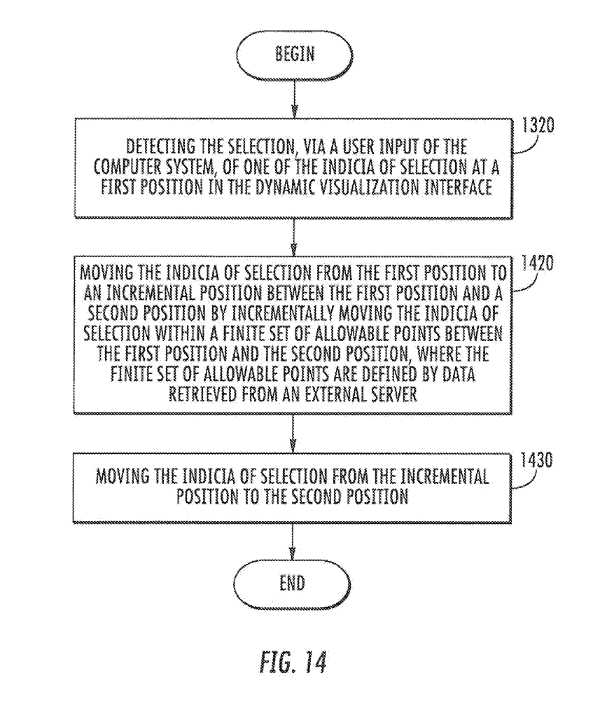

FIG. 14 illustrates various embodiments configured to move/adjust the indicia of selection within the dynamic visualization interface discussed with respect to FIGS. 12 and 13.

The embodiments may begin at operation 1320, described herein with respect to FIG. 13. As described herein, the computer system and the user input referred to with respect to FIG. 14 may be similar to the device 600 and input device(s) 690, respectively, discussed with respect to FIG. 10. In operation 1320, systems, methods, and computer program products may detect the selection, via a user input of the computer system, of one of the indicia of selection at a first position in the dynamic visualization interface.

The embodiments may continue with operation 1420, by moving the indicia of selection from the first position to an incremental position between the first position and a second position by incrementally moving the indicia of selection within a finite set of allowable points between the first position and the second position, where the finite set of allowable points are defined by data retrieved from an external server. The movement described with respect to operation 1420 may operate similarly to the movement of the price indicator 150 between hash marks 210 discussed with respect to FIG. 3. As discussed with respect to FIG. 3, the dynamic visualization interface may restrict movement of the indicia of selection between valid values for the underlying indicia of selection. In some embodiments, these valid values may be retrieved from a computer server external to the computer system. For example, the finite set of allowable points may represent the available prices for contracts that meet the criteria currently selected by the user. In such an example, the user may be limited to moving the price indicator 150 between the available prices. In some embodiments, the finite set of allowable points may be illustrated within the dynamic visualization interface, similarly to the hash marks 210 illustrated in FIG. 3.

It will be understood that the incremental movement described in operation 1420 does not require that each incremental movement be uniform. That is to say that the finite set of allowable points may have non-equal gaps between respective pairs of adjacent points in the finite set. For example, in some embodiments, each point in the finite set of allowable points may be separated by a single unit (e.g., 1, 2, 3, . . . ). In some embodiments, the points in the finite set of allowable points may be separated by variable units (e.g., 1, 1.5, 2.25, 3, 4.33, . . . ).

The embodiments may continue with operation 1430, by moving the indicia of selection from the incremental position to the second position. As described herein, each movement of the indicia of selection may further cause other operations to occur, such as regenerating the dynamic visualization interface described in operations 1230 and 1340. In some embodiments, the computer system may wait until the full movement is complete (e.g., the user has released a mouse button if performing a click-and-drag operation) before performing the subsequent operation. That is to say that the operations may wait for the user to complete movement of the indicia of selection before performing subsequent operations.

Embodiments of the present disclosure were described herein with reference to the accompanying drawings. Other embodiments may take many different forms and should not be construed as limited to the embodiments set forth herein. Like numbers refer to like elements throughout. Thus, the same or similar numbers may be described with reference to other drawings even if they are neither mentioned nor described in the corresponding drawing. Also, elements that are not denoted by reference numbers may be described with reference to other drawings.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the various embodiments described herein. As used herein, the term “and/or” includes any and all combinations of one or more of the associated listed items.

The terminology used herein is for the purpose of describing particular embodiments only and is not intended to be limiting to other embodiments. As used herein, the singular forms “a”, “an” and “the” are intended to include the plural forms as well, unless the context clearly indicates otherwise. It will be further understood that the terms “comprises,” “comprising,” “includes” and/or “including”, “have” and/or “having” when used herein, specify the presence of stated features, integers, steps, operations, elements, and/or components, but do not preclude the presence or addition of one or more other features, integers, steps, operations, elements, components, and/or groups thereof. Elements described as being “to” perform functions, acts and/or operations may be configured to or other structured to do so.

Unless otherwise defined, all terms (including technical and scientific terms) used herein have the same meaning as commonly understood by one of ordinary skill in the art to which various embodiments described herein belong. It will be further understood that terms used herein should be interpreted as having a meaning that is consistent with their meaning in the context of this specification and the relevant art and will not be interpreted in an idealized or overly formal sense unless expressly so defined herein.

As will be appreciated by one of skill in the art, various embodiments described herein may be embodied as a method, data processing system, and/or computer program product. Furthermore, embodiments may take the form of a computer program product on a tangible computer readable storage medium having computer program code embodied in the medium that can be executed by a computer.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wired, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computer environment or offered as a service such as a Software as a Service (SaaS).

Some embodiments are described herein with reference to flowchart illustrations and/or block diagrams of methods, systems and computer program products according to embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall support claims to any such combination or subcombination.

In the drawings and specification, there have been disclosed typical embodiments and, although specific terms are employed, they are used in a generic and descriptive sense only and not for purposes of limitation, the scope of the disclosure being set forth in the following claims.

What is claimed is:

1. A computer program product for electronically visualizing contracts, the computer program product comprising a non-transitory computer readable storage medium having computer readable program code embodied in the medium that when executed by at least one processor causes the at least one processor to perform operations comprising:
generating a dynamic visualization interface for display on a computer system, the dynamic visualization interface comprising:
at least one strike price selector extending in a first direction, the at least one strike price selector corresponding to a strike price associated with at least one contract to be electronically traded;
a first axis extending in a second direction, crossing the first direction, the first axis comprising a plurality of increasing prices of an underlying asset of the at least one contract, wherein the at least one strike price selector is configured to be graphically adjusted to select at least one of the plurality of increasing prices;
a graphical profit zone extending from the first axis and associated with a first group of the plurality of increasing prices, the graphical profit zone indicating a plurality of net profit values for the at least one contract that is associated with respective prices of the first group of the plurality of increasing prices; and
a graphical loss zone extending from the first axis and associated with a second group of the plurality of increasing prices, the graphical loss zone indicating a plurality of net loss values for the at least one contract that is associated with respective prices of the second group of the plurality of increasing prices;
monitoring one or more input devices of the computer system for adjustment to the at least one strike price selector;
responsive to the adjustment to the at least one strike price selector, regenerating the dynamic visualization interface to reconfigure the graphical profit zone and the graphical loss zone based on the at least one strike price selector;
dynamically and without user input retrieving updated market data associated with the at least one contract from a computer server external to the computer system; and
responsive to the updated market data associated with the at least one contract, regenerating the dynamic visualization interface to restrict movement of the at least one strike price selector to a subset of the plurality of increasing prices based on the updated market data.

2. A computer program product for electronically visualizing contracts, the computer program product comprising a non-transitory computer readable storage medium having computer readable program code embodied in the medium that when executed by at least one processor causes the at least one processor to perform operations comprising:
generating a dynamic visualization interface for display on a computer system, the dynamic visualization interface comprising:
a plurality of indicia of selection, respective ones of the plurality of indicia of selection corresponding to variables associated with at least one contract;
a plurality of increasing numbers corresponding to one or more of the plurality of indicia of selection; and
a graphical indication that indicates a plurality of magnitudes of values that are dependent on the indicia of selection;
monitoring one or more input devices of the computer system for adjustment to the one or more of the plurality of indicia of selection; and
responsive to the adjustment to the indicia of selection, regenerating the dynamic visualization interface to reconfigure the graphical indication to adjust respective ones of the plurality of magnitudes of the values for respective ones of the plurality of increasing numbers.

3. The computer program product of claim 2, wherein the plurality of increasing numbers corresponds to a plurality of prices, respectively, associated with an underlying asset of the at least one contract.

4. The computer program product of claim 2, wherein the plurality of indicia of selection comprises a strike price selector for the at least one contract.

5. The computer program product of claim 4, wherein the plurality of magnitudes of values comprises a value of a profit and/or a loss for the at least one contract based on a strike price indicated by the strike price selector and based on ones of the plurality of increasing numbers.

6. The computer program product of claim 4, wherein respective ones of the plurality of magnitudes of values are automatically and dynamically adjusted based on a market price of an underlying asset of the at least one contract that is retrieved over an electronic network.

7. The computer program product of claim 2, wherein monitoring the one or more input devices of the computer system for the adjustment to the one or more of the plurality of indicia of selection comprises:
detecting a selection, via a user input of the computer system, of an indicium of selection of the plurality of indicia of selection at a first position in the dynamic visualization interface; and
detecting a movement, via the user input of the computer system, of the indicium of selection of the plurality of indicia of selection to a second position in the dynamic visualization interface.

8. The computer program product of claim 4, wherein the adjustment of the strike price selector of the at least one contract is limited to a subset of the plurality of increasing numbers based on available prices of the at least one contract.

9. The computer program product of claim 8, wherein the subset of the plurality of increasing numbers is a first subset,
wherein the strike price selector is a first indicium of selection,
wherein the adjustment of the first indicium of selection is a first adjustment, and
wherein, responsive to a second adjustment of a second indicium of selection of the plurality of indicia of selection, a third adjustment of the first indicium of selection is limited to a second subset of the plurality of increasing numbers, different than the first subset.

10. The computer program product of claim 4, wherein the adjustment of the strike price selector comprises movement in a first direction of a graphical element of the dynamic visualization interface, and
wherein the graphical element extends in a second direction, crossing the first direction.

11. The computer program product of claim 2, wherein the at least one contract comprises a first contract and a second contract,
wherein a first indicium of selection of the plurality of indicia of selection is a first strike price selector corresponding to the first contract, and
wherein a second indicium of selection of the plurality of indicia of selection is a second strike price selector corresponding to the second contract.

12. The computer program product of claim 11, wherein the plurality of magnitudes of values comprises a value of a combined profit and/or a combined loss for the first contract and the second contract, and
wherein the value is based on a first strike price indicated by the first strike price selector and a second strike price indicated by the second strike price selector.

13. The computer program product of claim 2, wherein the plurality of increasing numbers is adjacent the graphical indication that indicates the plurality of magnitudes of values within the dynamic visualization interface.

14. The computer program product of claim 4, wherein the plurality of increasing numbers corresponds to a plurality of prices, respectively, associated with the at least one contract, and
wherein a respective one of the plurality of magnitudes of values comprises a value of a profit or a loss of the at least one contract based on a strike price indicated by the strike price selector and based on a price of the plurality of prices that is adjacent the respective one of the plurality of magnitudes of values.

15. The computer program product of claim 14, wherein the respective one of the plurality of magnitudes of values comprises a first color that indicates the loss associated with the at least one contract or a second color that color indicates the profit associated with the at least one contract.

16. The computer program product of claim 2, wherein the graphical indication is a polygon that is adjacent the plurality of increasing numbers.

17. A computer-implemented method for electronically visualizing contracts, comprising:
generating a dynamic visualization interface for display on a computer system, the dynamic visualization interface comprising:
a plurality of indicia of selection, respective ones of the plurality of indicia of selection corresponding to variables associated with at least one contract;
a plurality of increasing numbers corresponding to one or more of the plurality of indicia of selection; and
a graphical indication that indicates a plurality of magnitudes of values that are dependent on the indicia of selection;
monitoring one or more input devices of the computer system for adjustment to the one or more of the plurality of indicia of selection; and
responsive to the adjustment to the indicia of selection, regenerating the dynamic visualization interface to reconfigure the graphical indication to adjust respective ones of the plurality of magnitudes of the values for respective ones of the plurality of increasing numbers.

18. The method of claim 17, wherein the plurality of increasing numbers corresponds to a plurality of prices, respectively, associated with an underlying asset of the at least one contract.

19. The method of claim 17, wherein the plurality of indicia of selection comprises a strike price selector for the at least one contract.

20. The method of claim 19, wherein the plurality of magnitudes of values comprises a value of a profit and/or a loss for the at least one contract based on a strike price indicated by the strike price selector and based on ones of the plurality of increasing numbers.

21. The method of claim 19, wherein respective ones of the plurality of magnitudes of values are automatically and dynamically adjusted based on a market price of an underlying asset of the at least one contract that is retrieved over an electronic network.

22. The method of claim 17, wherein monitoring the one or more input devices of the computer system for the adjustment to the one or more of the plurality of indicia of selection comprises:
detecting a selection, via a user input of the computer system, of an indicium of selection of the plurality of indicia of selection at a first position in the dynamic visualization interface; and
detecting a movement, via the user input of the computer system, of the indicium of selection of the plurality of indicia of selection to a second position in the dynamic visualization interface.

23. The method of claim 19, wherein the adjustment of the strike price selector of the at least one contract is limited to a subset of the plurality of increasing numbers based on available prices of the at least one contract.

24. The method of claim 23, wherein the subset of the plurality of increasing numbers is a first subset,
wherein the strike price selector is a first indicium of selection,
wherein the adjustment of the first indicium of selection is a first adjustment, and
wherein, responsive to a second adjustment of a second indicium of selection of the plurality of indicia of selection, a third adjustment of the first indicium of selection is limited to a second subset of the plurality of increasing numbers, different than the first subset.

25. The method of claim 19, wherein the adjustment of the strike price selector comprises movement in a first direction of a graphical element of the dynamic visualization interface, and
wherein the graphical element extends in a second direction, crossing the first direction.

26. The method of claim 17, wherein the at least one contract comprises a first contract and a second contract,
wherein a first indicium of selection of the plurality of indicia of selection is a first strike price selector corresponding to the first contract, and
wherein a second indicium of selection of the plurality of indicia of selection is a second strike price selector corresponding to the second contract.

27. The method of claim 26, wherein the plurality of magnitudes of values comprises a value of a combined profit and/or a combined loss for the first contract and the second contract, and
wherein the value is based on a first strike price indicated by the first strike price selector and a second strike price indicated by the second strike price selector.

28. The method of claim 17, wherein the plurality of increasing numbers is adjacent the graphical indication that indicates the plurality of magnitudes of values within the dynamic visualization interface.

29. The method of claim 19, wherein the plurality of increasing numbers corresponds to a plurality of prices, respectively, associated with the at least one contract, and
wherein a respective one of the plurality of magnitudes of values comprises a value of a profit or a loss of the at least one contract based on a strike price indicated by the strike price selector and based on a price of the plurality of prices that is adjacent the respective one of the plurality of magnitudes of values.

30. The method of claim 29, wherein the respective one of the plurality of magnitudes of values comprises a first color that indicates the loss associated with the at least one contract or a second color that color indicates the profit associated with the at least one contract.

31. The method of claim 17, wherein the graphical indication is a polygon that is adjacent the plurality of increasing numbers.
